(19) United States
(12) Patent Application Publication
(10) Pub. No.: US 2011/0162512 A1
(43) Pub. Date: Jul. 7, 2011

(54) REINFORCED DRUM STICK

(76) Inventor: William John White, Townsville (AU)

(21) Appl. No.: 13/119,395

(22) PCT Filed: Sep. 18, 2009
(86) PCT No.: PCT/AU2009/001242

§ 371 Date: Mar. 16, 2011

(30) Foreign Application Priority Data
Sep. 18, 2008 (AU) 2008221524

(51) Int. Cl. G10D 13/02

(52) U.S. Cl. 84/422.4

(57) ABSTRACT

A reinforced drum stick (10) having a butt portion (14) and a striking portion (12), and a reinforcement means (20) extending from the striking portion (12) into at least a portion of the butt portion (14), the reinforcement means (20) adapted to prevent splintering, chipping, cracking, breaking or bowing of the drum stick (10), whilst retaining the feel and rebound characteristics of the dram stick (10), and enhancing the tonal consistency from drum stick (10) to drum stick (10).

### REFERENCE TO RELATED APPLICATIONS

The present application is a Section 371 National Stage application of and claims priority from PCT Application PCT/AU2009/001242, entitled “A REINFORCED DRUM STICK,” filed on Sep. 18, 2009, which itself claims priority from Australian Application AU/2008/221524, entitled “A REINFORCED DRUM STICK,” filed on Sep. 18, 2008, the entirety of both of which are hereby incorporated by reference herein.

### FIELD OF THE INVENTION

The present invention relates to a drum stick for striking drums, cymbals or other percussion instruments and more particularly to a reinforced drumstick having a natural “feel”.

### BACKGROUND OF THE INVENTION

Drum sticks are traditionally manufactured from wood. Wood is readily available, relatively inexpensive, and easily worked. Further, wooden drum sticks have a particular feel which many drummers prefer. That is, they vibrate sufficiently to provide a user with the sensory feedback relating to the impact of the drumstick, but generally not so much as to cause a user repetitive strain injury. Moreover, wooden drum sticks have certain rebound characteristics, such that they generate a distinctive sound and tone when contacting a percussion instrument, which many drummers prefer.

However, the distinctive sound and tone generated through contact with a percussion instrument may vary between one wooden drum stick and the next. Thus, it is difficult to obtain tonally matched pairs of wooden drum sticks.

Moreover, wooden drum sticks may splinter, chip, crack or break after a relatively short period of normal use. Thus, wooden drum sticks have a short life span and must be regularly replaced.

Finally, wooden drum sticks are prone to bowing. As the straightness of a drum stick is important to drummers, bowed drum sticks may be rejected or marked as seconds and sold at a discounted price. This wastage reduces manufacturer's profits.

In an effort to overcome the undesirable properties of wooden drum sticks while retaining their desirable characteristics, various combinations of non-wooden and composite materials have been proposed for the fabrication of drumsticks.

For example, drum sticks having a fiber-reinforced resin within the shaft are known. Although these drum sticks may be less prone to bowing, they do not overcome the undesirable properties of wooden drum sticks. Due to its location, the fiber-reinforced resin enhances the strength of the shaft. However, these drum sticks are more likely to splinter, chip, crack or break along the shoulder where the drum stick is tapered and is therefore weaker, and where the drum stick encounters most force as it contacts the drums, cymbals or other percussion instruments. Moreover, these drum sticks do not retain all of the desirable characteristics of wooden drum sticks. Again, due to its location, the fiber-reinforced resin dampens the vibration of the shaft, thereby negatively impacting the feel of the drum stick.

In addition, two part drum sticks having a fiberglass rod extending forwardly from the shoulder end of a wooden shall are known. The location of the reinforcement overcomes some of the disadvantages referred to above. However, these drum sticks do not retain all of the desirable characteristics of wooden drum sticks. As the fiberglass rod is not encased within the wooden drum stick, but extends independently of it, the beneficial rebound characteristics of wood are not preserved, thereby affecting the sound generated by the drum stick upon contact with a percussion instrument.

It is desirable for the reinforcement means to be positioned internally within the shoulder of a wooden drum stick in order to protect the shoulder from damage whilst retaining the feel of the drum stick and the beneficial rebound characteristics of wood.

Throughout this specification, the term “comprising” and its grammatical equivalents shall he taken to have an inclusive meaning unless the context of use indicates otherwise.

### SUMMARY OF THE INVENTION

It is an object of the present invention to substantially ameliorate the disadvantages of the prior art, or at least to provide a useful or commercial alternative. For example, one object of the present invention is to provide a reinforced drum stick having a gripping portion and a striking portion, and a reinforcement means located internally within the striking portion, the reinforcement means adapted to prevent splintering, chipping, cracking, breaking or bowing of the drum stick, whilst retaining the feel and rebound characteristics of the drum stick, and enhancing the tonal consistency from drum stick to drum stick.

With the foregoing in view, the present invention in one form, resides broadly in a drum stick comprising a grip portion; a striking portion; and a reinforcement means located internal to the striking portion.

According to a more particular form of the present invention, there is provided a drum stick comprising, a shaft having a butt portion, and a forward striking portion; and a reinforcement means extending from the striking portion into at least a portion of the butt portion, the reinforcement means located coaxially with the butt portion.

The drum stick will normally have a generally cylindrical cross-sectional shape, of any suitable predetermined diameter and length. The drumstick is normally divided into three main portions over its length, namely a tip, the butt and a tapering shoulder portion between the tip and the butt.

Preferably, the striking portion is located at the tip of the drumstick. Located between the tip and the butt of the drumstick is a shoulder, which tapers from a widest region at the point where the shoulder meets the butt to a narrowest region. The tip for striking a percussion instrument may be associated with the narrowest region of the shoulder. The tip may be integrally formed with the shoulder, or attached to it. The tip may be made of wood, or may be rubber or any other material.

Preferably, the butt portion comprises a shaft for a user to grip the drum slick. The grip portion may have a butt at one end, and may meet the shoulder at the other end.

The striking portion or the butt portion or both may be made of wood, such as hickory.

The reinforcement means may be a carbon fiber rod or any other reinforcement means of suitable rigidity and density, such as fiber-reinforced resin or a fiberglass rod.

The reinforcement means may be a generally cylindrical member, of any suitable predetermined diameter and length. The diameter and length are preferably adapted such that the reinforcement means is insertable into a hole through part of the central longitudinal axis of the drum stick, until one end of the reinforcement means extends 10-15 millimeters past the region where the shoulder meets the butt portion. and the other end of the reinforcement means no longer protrudes from the forward end of the drumstick. As such, the reinforcement means is preferably completely encased within the drumstick and surrounded by the wood of the drumstick.

Once in this position, the reinforcement means may be held in place by a press fit or by an adhesive such as glue.

The reinforcement means increases the strength and durability of the drum stick, without affecting the feel of the drum stick or the sound generated by it upon contact with a percussion instrument. Moreover, the rigidity and density of the reinforcement means assists in preventing bowing of the drum stick, and in the consistency of the tone of the drum stick (thereby easing the process of locating tonally matching pairs of drum sticks) respectively.

### BRIEF DESCRIPTION OF THE DRAWINGS

By way of example only, an embodiment of the invention is described more fully hereinafter with reference to the accompanying drawing, in which:

FIG. 1 is a side view of a drum stick according to a preferred embodiment of the present invention.

### DETAILED DESCRIPTION OF A PREFERRED EMBODIMENT OF THE INVENTION

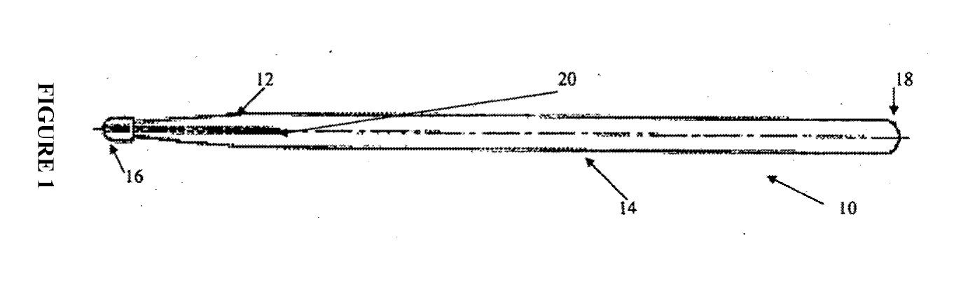

The drum stick 10 as shown in FIG. 1 comprises a shoulder 12, and a shaft 14. A tip 16 is associated with the shoulder 12. The shaft 14 has a butt 18 at one end. A carbon fiber rod 20 extends along the central longitudinal axis of the shoulder 12, from adjacent the tip of the drumstick to approximately 10-15 millimeters of the length of the central longitudinal axis of the shaft 14.

Although the invention has been herein shown and described in what is perceived to be the most practical and preferred embodiment, it is recognized that departures can be made within the scope of the invention, which is not to be limited to the details described herein but is to be accorded the full scope of the appended claims so as to embrace any arid all equivalent devices and apparatus.

What is claimed is:

1. A drum stick, comprising:
a shaft comprising a butt portion and a forward striking portion; and
a carbon fiber rod extending from the striking portion into at least a portion of the butt portion and located coaxially with the butt portion.

2. The drum stick of claim 1, wherein at least one of the striking portion and the butt portion is wooden.

3. The drum stick of claim 1, wherein the carbon fiber rod extends along approximately 10-15 millimeters of a length of the butt portion.

4. The drum stick of claim 2, wherein the carbon fiber rod extends along approximately 10-15 millimeters of a length of the butt portion.
